(19) United States
(12) Patent Application Publication
(10) Pub. No.: US 2026/0156344 A1
(43) Pub. Date: Jun. 4, 2026

(54) INFORMATION PROCESSING APPARATUS, IMAGE PICKUP APPARATUS, INFORMATION PROCESSING METHOD, AND STORAGE MEDIUM

(71) Applicant: CANON KABUSHIKI KAISHA, Tokyo (JP)

(72) Inventor: HIROSHI KISHINO, Kanagawa (JP)

(21) Appl. No.: 19/368,633

(22) Filed: Oct. 24, 2025

(30) Foreign Application Priority Data
Dec. 2, 2024 (JP) 2024-209681

(51) Int. Cl. H04N 23/63; H04N 23/55; H04N 23/69; H04N 23/695

(52) U.S. Cl. CPC H04N 23/632; H04N 23/55; H04N 23/634; H04N 23/69; H04N 23/695

(57) ABSTRACT

Information processing apparatuses, image pickup apparatuses, information processing methods, and storage media are provided herein. One or more information processing apparatuses may include one or more memories storing instructions, and one or more processors that, upon execution of the instructions, operate to acquire preset item information, cause a display unit to display the preset item information, and cause the display unit to change a display content of the preset item information according to whether at least one of a lens apparatus and an image pickup apparatus can execute an operation corresponding to the preset item information.

### BACKGROUND

### Field of the Technology

The aspect of the disclosure relates to one or more embodiments of an information processing apparatus, an image pickup apparatus, an information processing method, and a storage medium.

### Description of the Related Art

Some cameras with at least one of the pan, tilt, and zoom functions have a function that allows an angle of view to be quickly moved to a desired position by presetting the angle of view. This function is called a preset function. Image quality parameters such as focus, exposure, white balance, etc. can be registered in the preset function. Japanese Patent Application Laid-Open No. 2016-58984 discloses a method for storing pan, tilt, and zoom positions and image quality parameters by the user selection and displaying a list of preset functions. Japanese Patent Application Laid-Open No. 2013-198136 discloses a method for explicitly indicating to the user whether or not a preset function has been registered.

The methods disclosed in Japanese Patent Applications Laid-Open Nos. 2016-58984 and 2013-198136 do not display information indicating whether each preset item is executable, and thus it is difficult for the user to determine whether each registered preset item is operable, for example, in a case where a lens (apparatus) is interchanged.

### SUMMARY

One or more embodiments of an information processing apparatus according to one or more aspects of the disclosure may include one or more memories storing instructions, and one or more processors that, upon execution of the instructions, operate to acquire preset item information, cause a display unit to display the preset item information, and cause the display unit to change a display content of the preset item information according to whether at least one of a lens apparatus and an image pickup apparatus can execute an operation corresponding to the preset item information. One or more embodiments of an image pickup apparatus may include one or more image processing apparatuses in accordance with one or more other aspects of the disclosure. One or more image processing methods corresponding to the above one or more image processing apparatuses also constitute another aspect of the disclosure. A storage medium storing a program that causes a computer to execute the above one or more image processing methods also constitutes another aspect of the disclosure.

Features of the disclosure will become apparent from the following description of embodiments with reference to the attached drawings. The following description of embodiments will be provided by way of example.

### BRIEF DESCRIPTION OF THE DRAWINGS

FIG. 1 is a block diagram of an image pickup apparatus according to a first embodiment.

FIG. 2 is a flowchart illustrating an example of registration processing of a preset item in each embodiment.

FIG. 3 is a flowchart illustrating an example of processing for displaying registered preset items in the first embodiment.

FIGS. 4A, 4B, 4C, 4D, and 4E illustrate display examples of preset items in a case where angle (zoom) control is available in each embodiment.

FIGS. 5A, 5B, 5C, 5D, and 5E illustrate display examples of preset items in a case where angle (pan, tilt, zoom) control is available in each embodiment.

FIGS. 6A, 6B, 6C, 6D, 6E, 6F, 6G, and 6H illustrate display examples of preset items in a case where angle (zoom) control is not available in the first embodiment.

FIGS. 7A, 7B, 7C, 7D, 7E, 7F, 7G, and 7H illustrate display examples of preset items in a case where angle (pan, tilt, zoom) control is not available in the first embodiment.

FIGS. 8A, 8B, 8C, 8D, 8E, and 8F illustrate alert examples of causes in a case where zoom control is not available in the first embodiment.

FIGS. 9A, 9B, 9C, 9D, 9E, and 9F illustrate alert examples of causes in a case where angle (pan, tilt) control is not available in the first embodiment.

FIG. 10 illustrates an example of pan, tilt, and zoom mobility restrictions in each embodiment.

FIG. 11 illustrates an example of pan, tilt, and zoom mobility restrictions for each lens in each embodiment.

FIG. 12 is a block diagram of an imaging system according to a second embodiment.

FIG. 13 is a flowchart illustrating an example of display processing for registered preset items in the second embodiment.

FIGS. 14A, 14B, 14C, 14D, 14E, 14F, and 14G illustrate display examples of preset items in a case where reproduction control is not available to an angle (zoom) position in the second and third embodiments.

FIGS. 15A, 15B, 15C, 15D, 15E, 15F, and 15G illustrate display examples of preset items in a case where reproduction control is not available to an angle (pan, tilt, zoom) position in the second and third embodiments.

FIGS. 16A, 16B, 16C, 16D, 16E and 16F illustrate alert examples of causes in a case where reproduction control is not available to a zoom position in the second and third embodiments.

FIGS. 17A, 17B, 17C, 17D, 17E, and 17F illustrate alert examples of causes in a case where reproduction control is not available to an angle (pan, tilt) position in the second and third embodiments.

FIG. 18 is a block diagram of an information processing apparatus according to the third embodiment.

FIG. 19 is a flowchart illustrating an example of display processing of registered preset items in the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

A first embodiment will discuss an example in which an image-pickup-apparatus (IPA) control unit 120 of an image pickup apparatus (information processing apparatus) 100 displays controllable and uncontrollable items from among the registered preset items.

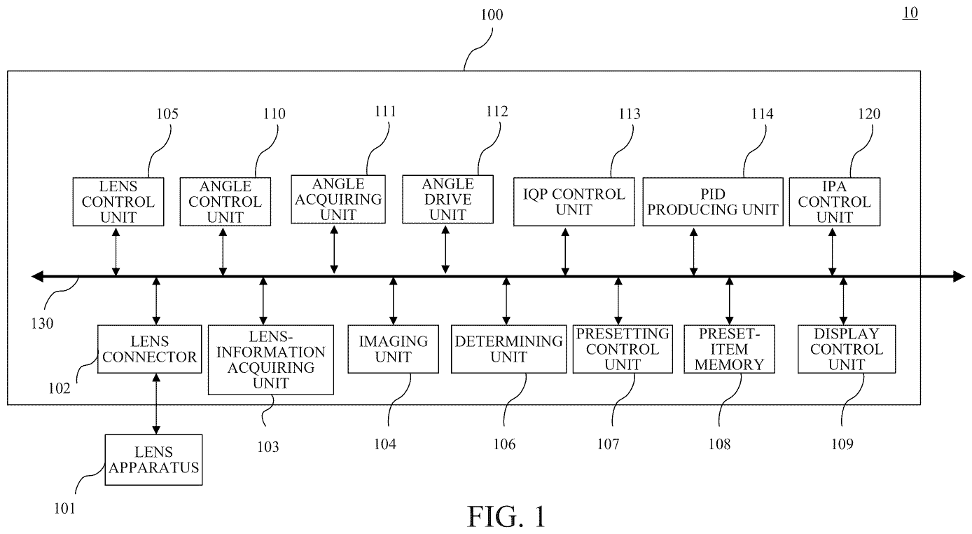

FIG. 1 is a block diagram of an imaging system 10 according to this embodiment. The imaging system 10 includes an image pickup apparatus (camera body) 100 and a lens apparatus 101 that is attachable to and detachable from the image pickup apparatus 100. However, this embodiment is not limited to this example and is applicable to an image pickup apparatus in which a camera body and a lens apparatus are integrated.

The image pickup apparatus 100 includes a lens connector 102, a lens-information acquiring unit 103, an imaging unit 104, a lens control unit 105, a determining unit (angle-controllability determining unit) 106, a presetting control unit 107, a preset-item memory 108, a display control unit 109, an angle control unit 110, an angle acquiring unit 111, an angle drive unit 112, an image-quality-parameters (IQP) control unit 113, a preset item display (PID) producing unit 114, the IPA control unit 120, and a data bus 130.

The IPA control unit 120 is a unit for controlling the imaging system 10, and as will be described below, controls the lens control unit 105, the presetting control unit 107, the display control unit 109, the angle control unit 110, and the IQP control unit 113. The IPA control unit 120 includes a CPU (one or more processors), memory (one or more memories) storing instructions, and nonvolatile memory. The memory is, for example, RAM (a volatile memory that uses a semiconductor device). The nonvolatile memory stores a variety of programs for the CPU to operate. The nonvolatile memory includes, for example, a hard disk drive (HDD) or ROM. The CPU uses the memory as a work memory for various processing and controls of each component in the image pickup apparatus 100 in accordance with, for example, programs stored in the nonvolatile memory. The CPU also stores camera settings (setting information for the image pickup apparatus 100), such as image quality parameters for the image pickup apparatus 100, such as focus, exposure, white balance, and color settings, as well as movable limit settings (movable limit ranges) for at least one of zoom, pan, and tilt. The camera settings are also stored in the nonvolatile memory. At least one of the movable limit settings for zoom, pan, and tilt may have a separate state for each lens. Each component is controlled by a program running on the IPA control unit 120, and data is communicable between them via the data bus 130.

The lens apparatus 101, also known as a lens unit, includes an imaging optical system including a fixed lens, a zoom lens, an aperture stop (diaphragm), and a focus lens. The aperture stop is driven by an aperture drive unit to control a light amount incident on an image sensor (described below). The focus lens is driven by a focus lens drive unit for focusing. The zoom lens is driven by a zoom lens drive unit for adjusting a zoom magnification. The lens apparatus 101 may have no zoom function (a fixed focal length lens). The lens apparatus 101 may also include a teleconverter.

The lens connector 102 can connect the interchangeable lens apparatus 101 and the image pickup apparatus 100, and the image pickup apparatus 100 and lens apparatus 101 communicate with each other via the lens connector 102. This communication involves sending zoom and focus drive commands to the lens apparatus 101, and sending and receiving data such as the internal operating status and optical information on the image pickup apparatus 100 and lens apparatus 101.

The lens-information acquiring unit 103 is a unit that acquires information about the lens apparatus 101 (lens information) via the lens connector 102. The lens information includes, for example, the lens model, the type of lens apparatus (e.g., compound lens, fisheye lens, telephoto lens, etc.), a focal length range including the telephoto end and wide-angle end, whether a teleconverter is used, setting information such as the switch status, and information on whether a lens is attached or not.

The imaging unit 104 includes an image sensor such as a Charge Coupled Device (CCD) or Complementary Metal Oxide Semiconductor (CMOS) sensor that converts captured light into an electrical signal. An image processing circuit (not illustrated) performs various image processing for the electrical signal and converts it into a video signal, allowing still and moving images to be stored in a memory (storage) (not illustrated).

The lens control unit 105 controls the lens apparatus 101 via the lens connector 102. In a case where the user operates the aperture stop, focus lens, zoom lens, etc. via the lens control unit 105, the lens control unit 105 performs control in accordance with the user operation. The lens control unit 105 also controls the aperture drive unit, focus (lens) drive unit, and zoom (lens) drive unit in accordance with control commands and control information received from the IPA control unit 120. The lens control unit 105 transmits lens information (e.g., manual focus operation information and information about the imaging optical system) to the IPA control unit 120.

The determining unit 106 determines whether at least one of zoom, pan, and tilt (imaging angle of view) control is available, i.e., whether an operation corresponding to each registered preset item (information on the imaging angle of view) is executable. The determining unit 106 can determine whether control corresponding to each registered preset item is available using one or both of the lens information acquired from the lens-information acquiring unit 103 and the camera settings stored in the memory of the IPA control unit 120. The zoom control determination made by the determining unit 106 may be based not only on whether zoom control is available but also on the type of lens apparatus.

The presetting control unit 107 acquires current pan/tilt angle information from the angle acquiring unit 111 in accordance with the control command and control information received from the IPA control unit 120. The presetting control unit 107 also acquires current zoom information from the lens-information acquiring unit 103. The presetting control unit 107 also acquires a still image produced by the imaging unit 104. The presetting control unit 107 also acquires image quality parameters stored in the memory of the IPA control unit 120. The presetting control unit 107 then stores at least one of them as a set of preset item information in the preset-item memory 108, which will be described later.

For example, in a case where a preset item registered by the user via the IPA control unit 120 is called up, the presetting control unit (acquiring unit) 107 acquires the preset item information from the preset-item memory 108. The presetting control unit 107 then sends a control command to the angle control unit 110 and the IQP control unit 113 to reproduce the angle position and image quality parameters based on this information. The presetting control unit 107 can also send a control command to the angle control unit 110 and the IQP control unit 113 to reproduce the angle position and image quality parameters, excluding items determined to be uncontrollable by the determining unit 106.

The term “preset” may refer to a preset function that can reproduce a desired imaging condition, such as pan, tilt, and zoom, or image quality parameters, by previously storing the condition. However, the term “preset” may also refer to a trace function. The trace function stores pan, tilt, zoom, and other operations performed by the user within a certain period of time in the preset-item memory 108. The trace function record (trace record) stored in the preset-item memory 108 can be played back at an arbitrary timing to reproduce panning, tilting, zooming, etc., performed by the user. With the trace function, the preset-item memory 108 stores the playback start position for playing back the trace record, in addition to control information performed by the user within a certain period of time. In a case where an instruction to move to the playback start position is given during playback of the trace record, the unit moves to the playback start position stored in the preset-item memory 108 and then plays back the trace record.

The preset-item memory 108 includes a memory and a nonvolatile memory, and stores a set of preset item information in the memory and nonvolatile memory in accordance with control commands and control information received from the presetting control unit 107. The memory sends the set of preset item information stored in the nonvolatile memory to the presetting control unit 107.

The display control unit 109 acquires the display content of the preset item (display content of the preset function) produced by the PID producing unit 114 in accordance with control commands and control information received from the IPA control unit 120. The display control unit 109 edits display data to be displayed on a display device (display apparatus, display unit) (not illustrated) and controls the display.

The angle control unit 110 controls the driving of at least one of the zoom, pan, and tilt of the image pickup apparatus 100 in accordance with control commands and control information received from the IPA control unit 120, and issues an angle driving command and controls the driving of the angle drive unit 112.

The angle acquiring unit 111 acquires current pan/tilt angle information from the angle control unit 110, and acquires current zoom information from the lens-information acquiring unit 103.

The angle drive unit 112 is a driving unit that rotates the image pickup apparatus 100 in the pan direction and tilt direction, or a unit that drives the zoom of the lens apparatus 101 via the lens control unit 105. The angle drive unit 112 can change at least one of the imaging direction and zoom position of the image pickup apparatus 100. The angle drive unit 112 includes a motor for pan rotation and a motor for tilt rotation to drive the pan and tilt, and these motors rotate to perform the rotation drive. Each motor includes an encoder such as a pulse encoder, and the rotation position of the motor can be detected.

The IQP control unit 113 is a unit for controlling the image quality parameters of the image pickup apparatus 100 in accordance with a control command and control information received from the IPA control unit 120.

The PID producing unit 114 acquires preset item information stored in the preset-item memory 108 and produces the display content of the preset item. The PID producing unit 114 can edit the display content of the preset item based on the determination result of the determining unit 106.

A description will now be given of a flow of processing executed by the IPA control unit 120, which controls the image pickup apparatus 100.

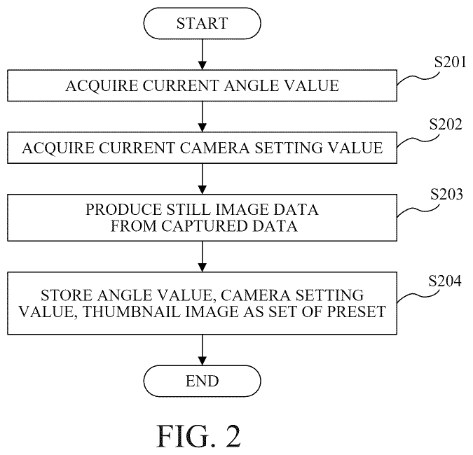

FIG. 2 is a flowchart of the registration processing of the preset items in the IPA control unit 120. The processing of the flowchart in FIG. 2 is achieved by the CPU of the IPA control unit 120, which controls the image pickup apparatus 100, executing a program according to this embodiment. The entire processing of the flowchart in FIG. 2 may be achieved by a hardware configuration, or some of the processing may be performed by a hardware configuration and the remaining processing may be performed by a software configuration based on a program. This is similarly applied to the processing of each flowchart described below. In the following explanation, steps S201 to S204 of the flowchart in FIG. 2 will be abbreviated as S201 to S204, respectively. In the case of trace recording, the processing of S201 to S204 may be performed multiple times in one trace recording. In this case, the processing of S202 and S203 does not necessarily have to be performed every time.

First, in S201, the IPA control unit 120 acquires at least one of the current zoom, pan, and tilt positions from the angle acquiring unit 111 and stores them in the presetting control unit 107. The flow then proceeds to S202.

In S202, the IPA control unit 120 acquires the image quality parameters stored in the memory of the IPA control unit 120 and stores them in the presetting control unit 107. The flow then proceeds to S203.

In S203, the IPA control unit 120 captures an image of the current position using the imaging unit 104 and stores the captured image (still image data) in the presetting control unit 107. The flow then proceeds to S204. The order of steps S201 to S203 is not particularly limited, and the order of steps S201 to S203 may be reversed, or steps S201 to S203 may be executed simultaneously (in parallel).

When the flow proceeds to S204, the IPA control unit 120 saves at least one of the zoom, pan, and tilt positions, the image quality parameters, and the still image stored in the presetting control unit 107 in S201 to S203 as a set of preset item information in the preset-item memory 108. The IPA control unit 120 then terminates the registration processing of the preset item.

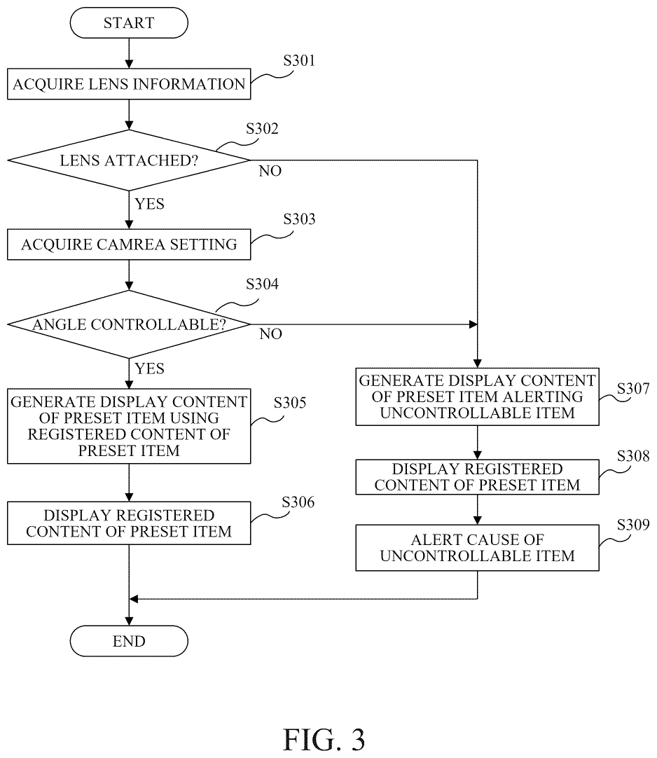

FIG. 3 is a flowchart illustrating an example of display processing for a registered content of a preset item by the image pickup apparatus 100 according to this embodiment. In FIG. 3, lens information may be information about the lens type, focal length, and lens switch (SW) status. This processing may be performed, for example, when a lens is interchanged, at an arbitrary timing by the user, or at a timing when the preset item information is displayed on the display device or the like. In a case where multiple preset items are registered, this flow may be performed for each preset item. It may also be performed for some or all of the registered preset items. In this case, there are no particular limitations on which preset item is processed, which preset item is not processed, or the processing order of the preset items to be processed. In the following description, steps S301 to S309 in the flowchart in FIG. 3 will be abbreviated as S301 to S309, respectively.

First, in S301, the IPA control unit 120 acquires lens information about the currently attached lens apparatus 101 from the lens-information acquiring unit 103 via the data bus 130. The lens information includes at least one of the focal length range of the lens apparatus 101 (information about a focal length), information indicating the type of lens apparatus 101, information indicating the switch status of the lens apparatus 101, and information indicating whether the lens apparatus 101 is attached. The information indicating the switch status of the lens apparatus 101 includes, for example, information indicating whether a power zoom function of the lens apparatus 101 is enabled. In a case where the currently attached lens is a fixed focal length lens, the focal length range will be a single focal length value of the fixed focal length lens. In this case, subsequent processing is performed assuming that this focal length is both the wide-angle end and the telephoto end. The flow then proceeds to S302.

In S302, the IPA control unit 120 uses the lens information acquired in S301 as the determination basis and determines whether a lens is attached to the image pickup apparatus 100. In a case where it is determined that the lens is attached, the flow proceeds to S303; in a case where it is determined that the lens is not attached, the flow proceeds to S306.

In S303, the IPA control unit 120 acquires information on at least one of the movable limit settings for zoom, pan, and tilt, which are stored in the memory of the IPA control unit 120. The flow then proceeds to processing in S304, and the movable limit settings for zoom, pan, and tilt for each lens.

In S304, the IPA control unit 120 uses either or both of the lens information acquired in S301 and the camera settings acquired in S303 as the determination basis and determines whether at least one of the zoom, pan, and tilt controls is available by the image pickup apparatus 100. In a case where lens information is used as the determination basis, it is determined whether zoom control is available based on at least one of the following conditions: whether the lens is a zoom lens, whether the zoom of the lens is controllable by a motor, and whether the zoom motor control SW is automatic. In a case where the camera setting is used as the determination basis, it is determined whether at least one of pan, tilt, and zoom control is available using the movable limits for at least one of pan, tilt, and zoom and the movable limits for at least one of pan, tilt, and zoom for each lens. In a case where the angle control is available, the flow proceeds to S305; in a case where the angle control is not available, the flow proceeds to S307.

In S305, the IPA control unit 120 produces a display content of a preset item using the preset item information stored in the preset-item memory 108 through the PID producing unit 114. The display content produced here is not particularly limited, and may include a list display, summary display, or icon display of the registered content of the preset item information, or a thumbnail display in a case where the preset item information includes a still image. The flow then proceeds to S306.

In S306, the IPA control unit 120 displays the display content of the preset item produced by the PID producing unit 114 on the display device (display apparatus, display unit) or the like via the display control unit 109. Thereafter, the flow ends the processing to be executed in a case where preset item information is displayed based on the lens information and camera setting of the registered content of the preset item.

In S307, the IPA control unit 120 uses the PID producing unit 114 and produces a display content of a preset item for alerting the preset item information stored in the preset-item memory 108 of the content determined to be uncontrollable in S304. Here, the display for alerting the control determined unavailable in S304 is not particularly limited, as long as it is different from the display content of a preset item produced in S305. For example, the item may be displayed as not being operable, or the color of the item may be changed or hidden. As another example, an icon may be displayed, or a thumbnail may be displayed by replacing it with an image quality parameter. The flow then proceeds to S308.

In S308, the IPA control unit 120 displays the display content of the preset item produced by the PID producing unit 114 on the display device or the like via the display control unit 109. The flow then proceeds to S309. In a case where the processing of S309 is omitted, the IPA control unit 120 then terminates the processing executed when displaying preset item information based on the lens information and camera setting of the registered content of the preset item.

In S309, the IPA control unit 120 displays an alert on the display device or the like via the display control unit 109, indicating the cause of control not available for the content of the preset item information stored in the preset-item memory 108 determined to be uncontrollable in S304. Here, the alert display is not particularly limited, and the cause content may be displayed, an icon of the cause may be displayed, or the cause may be displayed by selecting an object. In this embodiment, the processing of S309 may be omitted. Thereafter, the IPA control unit 120 ends the processing executed when the preset item information is displayed based on the lens information and camera setting of the registered content of the preset items.

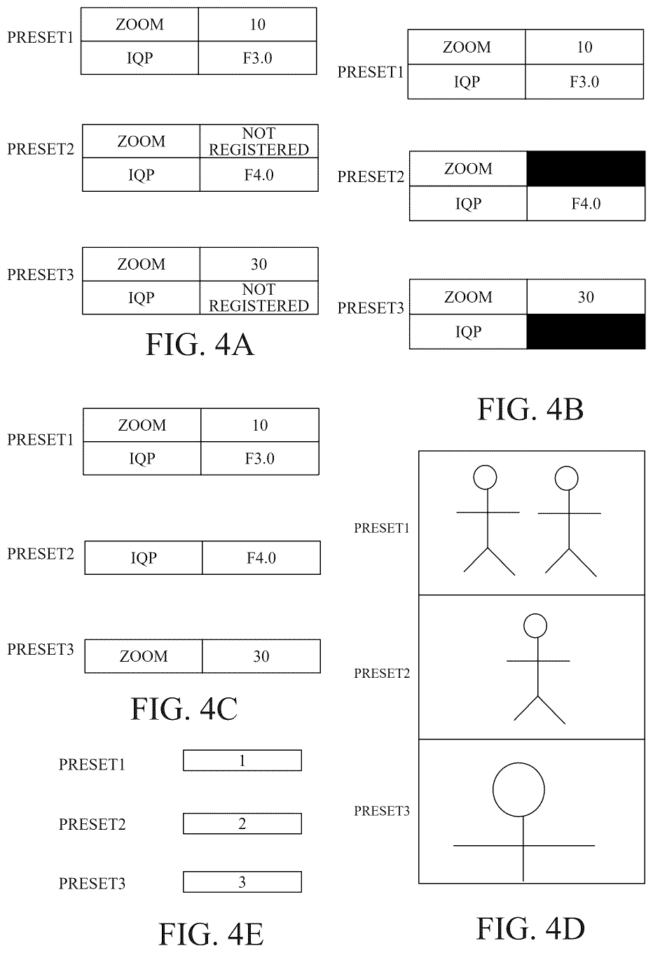

FIGS. 4A, 4B, 4C, 4D, and 4E illustrate examples of the display contents of the preset item information in the image pickup apparatus 100, which is capable of zooming, in the processing of S306. FIGS. 4A, 4B, and 4C illustrate examples of the preset item information. FIG. 4D illustrates an example of a still image within the preset item information. FIG. 4E illustrates an example of an icon display.

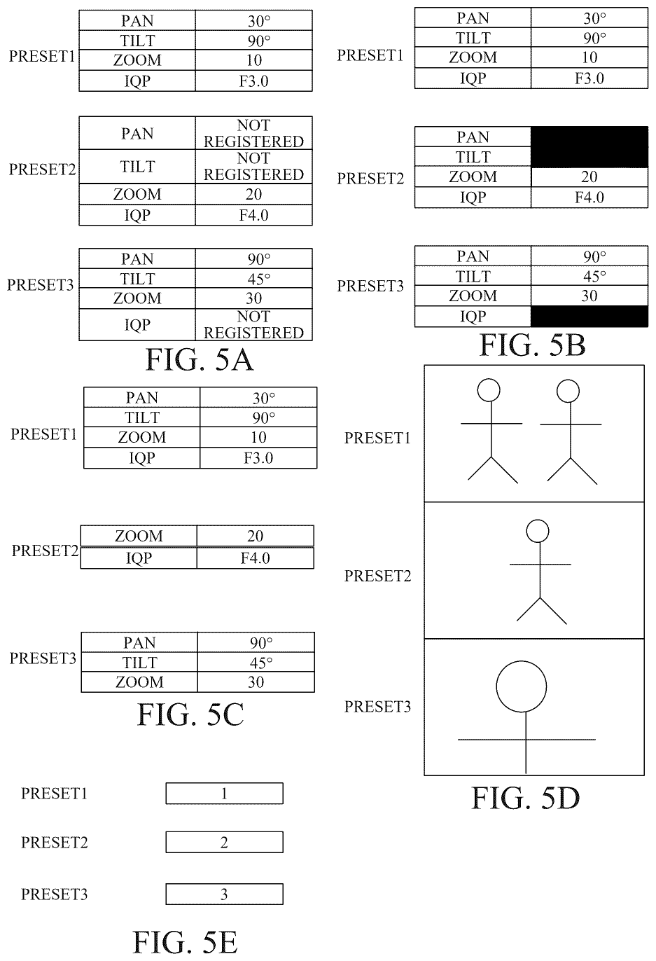

FIGS. 5A, 5B, 5C, 5D, and 5E illustrate examples of the display contents of the preset item information in the image pickup apparatus 100, which is capable of panning, tilting, and zooming in the processing of S306. FIGS. 5A, 5B, and 5C illustrate examples of the preset item information. FIG. 5D illustrates an example of a still image within the preset item information. FIG. 5E illustrates an example of an icon display.

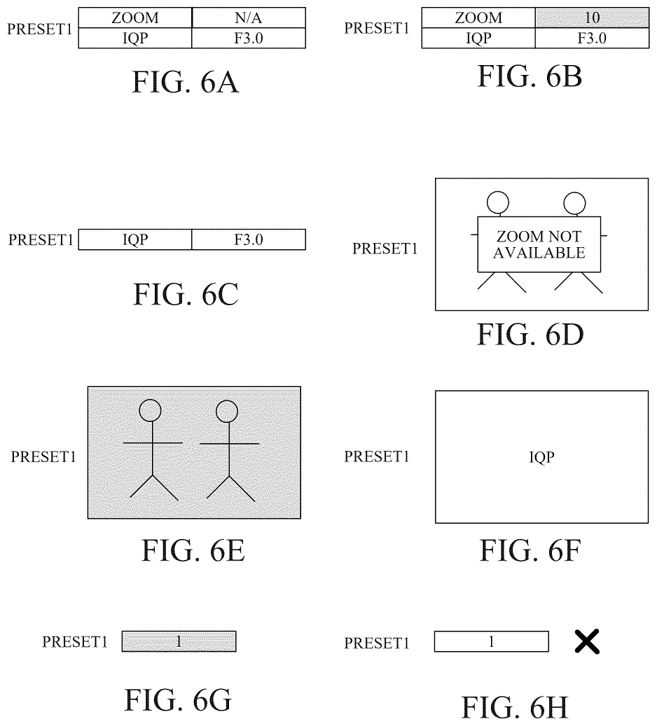

FIGS. 6A, 6B, 6C, 6D, 6E, 6F, 6G, and 6H illustrate examples of the display contents of preset item information for alerting items that cannot be zoom-controlled in the image pickup apparatus 100, which is capable of zooming in the processing of S308.

FIG. 6A illustrates an alert example indicating that zoom control is not available, with the text “N/A.” FIG. 6B illustrates an alert example indicating that zoom control is not available by graying out the zoom item. FIG. 6C illustrates an alert example indicating that zoom control is not available by hiding the zoom item. FIG. 6D illustrates an alert example indicating that zoom control is not available, with the text “zoom not available” on a still image in the preset item information.

FIG. 6E illustrates an alert example indicating that zoom control is not available by graying out a still image in the preset item information. FIG. 6F illustrates an alert example indicating that zoom control is not available by displaying the image quality parameter in the preset item information in the display area of a still image in the preset item information. FIG. 6G illustrates an alert example indicating that zoom control is not available using a grayed-out icon. FIG. 6H is an alert example indicating that zoom control is not available using an icon displayed indicating that zoom control is not available.

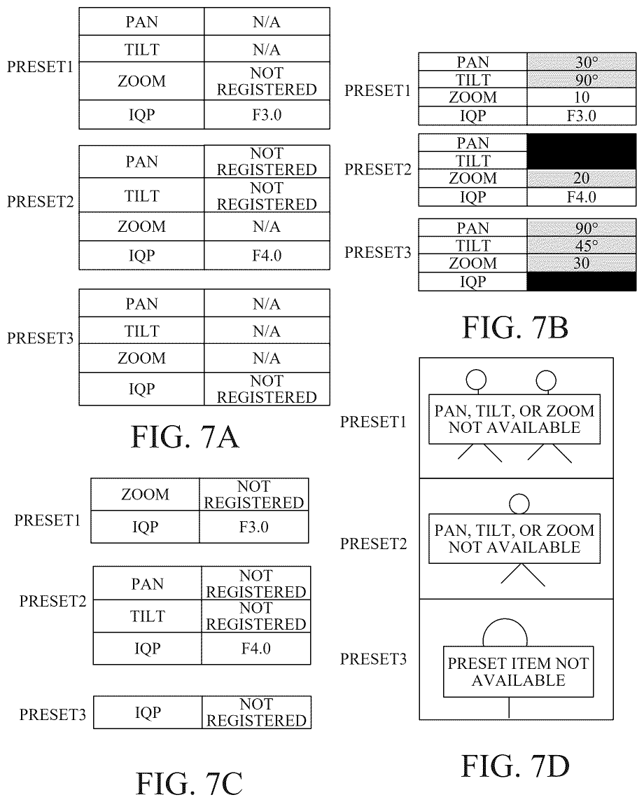

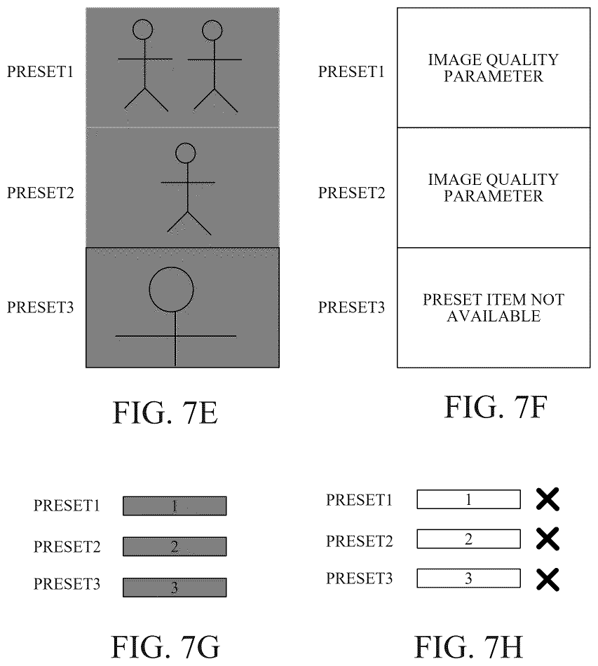

FIGS. 7A, 7B, 7C, 7D, 7E, 7F, 7G, and 7H illustrate examples of the display contents of preset item information for alerting that at least one of the zoom, pan, and tilt items cannot be controlled in the image pickup apparatus 100, which is capable of panning, tilting, and zooming in the processing of S308. The examples in FIGS. 7A, 7B, 7C, 7D, 7E, 7F, 7G, and 7H illustrate display examples of the preset item information where all of the pan, tilt, and zoom controls are not available, but uncontrollability may be displayed for each of panning, tilting, and zooming.

FIG. 7A illustrates an alert example that all of the zoom, pan, and tilt controls are not available, with the text “N/A” for the zoom, pan, and tilt items. FIG. 7B illustrates an alert example that all of zoom, pan, and tilt controls are not available by graying out the zoom, pan, and tilt items. FIG. 7C illustrates an alert example that all of pan, tilt, and zoom controls are not available by hiding the uncontrollable items. FIG. 7D illustrates an alert example on a still image in the preset item information indicating that all of pan, tilt, and zoom controls are not available, with the text “pan, tilt, or zoom not available.”

FIG. 7E illustrates an alert example indicating that all of pan, tilt, and zoom controls are not available by graying out a still image (captured image) in the preset item information. FIG. 7F illustrates an alert example on a still image in the preset item information indicating that all of pan, tilt, and zoom controls are not available using the image quality parameter in the preset item information in the display area of the still image. FIG. 7G illustrates an alert example on a grayed-out icon indicating that all of pan, tilt, and zoom controls are not available. FIG. 7H illustrates an alert example on an icon indicating uncontrollability, i.e., that all of pan, tilt, and zoom controls are not available.

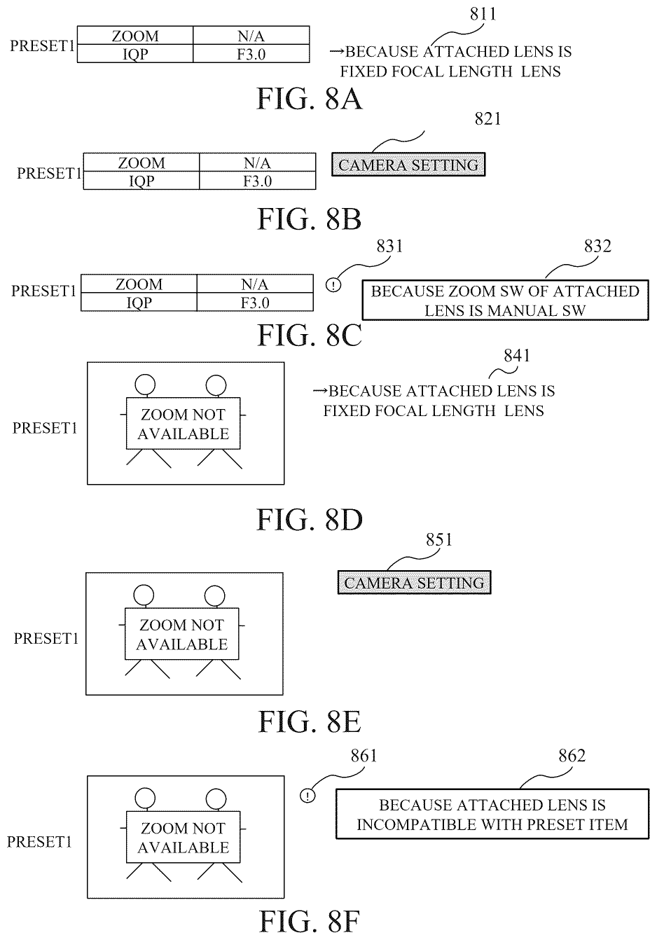

FIGS. 8A, 8B, 8C, 8D, 8E, and 8F illustrate alert examples in the processing of S309 of the causes of zoom control not available in the image pickup apparatus 100, which is capable of zooming.

FIG. 8A illustrates an alert example of the cause of zoom control not available using text. Reference numeral 811 denotes a text example indicating that zoom control is not available, but it is not limited to this example. FIG. 8B illustrates an alert example of the cause of zoom control not available using an icon. Reference numeral 821 denotes an alert example of the cause of zoom control not available using a camera setting icon, but it is not limited to this example. FIG. 8C illustrates an alert example of the cause of zoom control not available by selecting an object. Reference numeral 831 denotes an example of an object indicating the cause of zoom control not available, and reference numeral 832 denotes an example of displaying the cause of zoom control not available that appears by operating the object 831, but it is not limited to this example.

FIG. 8D illustrates an alert example of the cause of zoom control not available using text. Reference numeral 841 denotes a text example indicating that zoom (control) is not available, but it is not limited to this example. FIG. 8E illustrates an alert example of the cause of zoom control not available using an icon. Reference numeral 851 denotes an alert example of the cause of zoom control not available using a camera setting icon, but it is not limited to this example. FIG. 8F illustrates an alert example of the cause of zoom control not available by selecting an object. Reference numeral 861 denotes an example of an object indicating the cause of zoom control not available, and reference numeral 862 denotes a display example of the cause of zoom control not available that appears by operating the object 861, but it is not limited to this example.

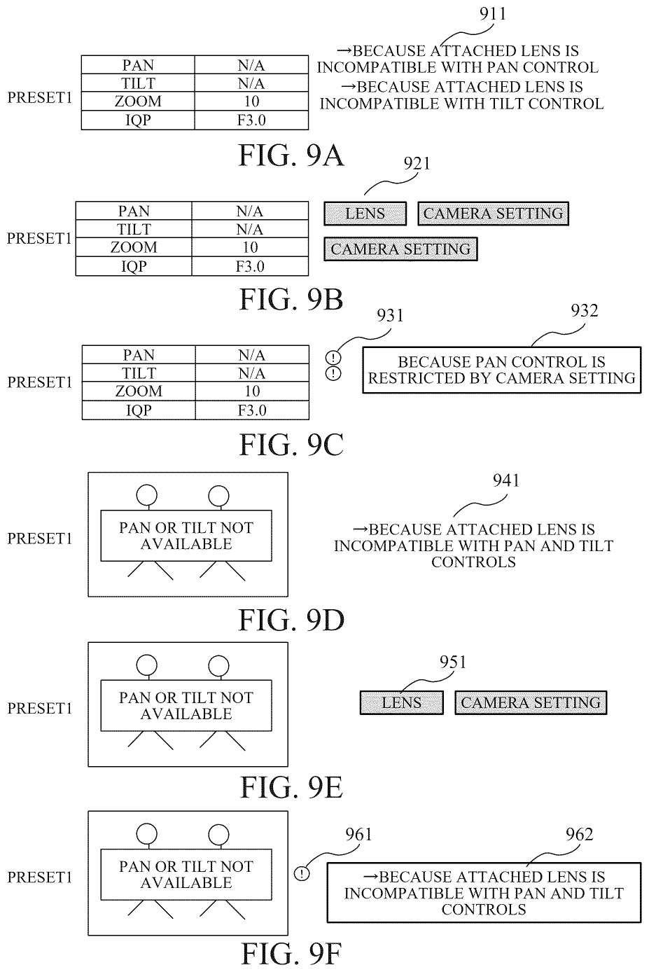

FIGS. 9A, 9B, 9C, 9D, 9E, and 9F illustrate alert examples of the causes of pan and tilt controls not available in the image pickup apparatus 100, which is capable of pan, tilt, and zoom, in the processing of S309.

FIG. 9A illustrates an alert example of the cause of pan and tilt controls not available using text. Reference numeral 911 denotes an alert example of the cause of pan control not available, but it is not limited to this example. FIG. 9B illustrates an alert example of the cause of pan and tilt controls not available using an icon. Reference numeral 921 denotes an alert example of the cause of pan control not available using a lens icon, but it is not limited to this example. FIG. 9C illustrates an alert example of the cause of pan and tilt controls not available by selecting an object. Reference numeral 931 denotes an example of an object indicating the cause of pan control not available, and reference numeral 932 denotes a display example of the cause of pan control not available that appears by operating the object 931, but it is not limited to this example.

FIG. 9D illustrates an alert example of the cause of pan and tilt controls not available using text. Reference numeral 941 denotes a display example of the cause of pan and tilt controls not available using text, but it is not limited to this example. FIG. 9E illustrates an alert example of the cause of pan and tilt controls not available using an icon. Reference numeral 951 denotes a display example of the cause of pan and tilt controls not available using a lens icon, but it is not limited to this example. FIG. 9F illustrates an alert example of the cause of pan and tilt controls not available by selecting an object. Reference numeral 961 denotes an example of an object indicating the cause of pan control not available, and reference numeral 962 denotes a display example of the cause of pan control not available that appears by operating the object 961, but it is not limited to this example.

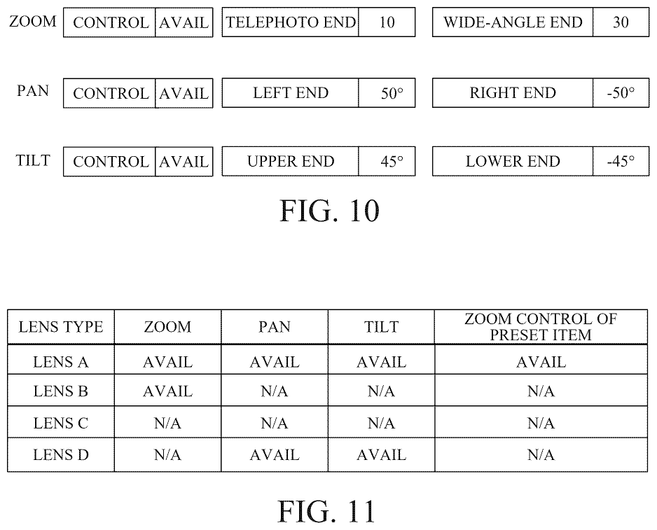

FIG. 10 illustrates an example of movable restrictions of the pan, tilt, and zoom in the image pickup apparatus 100. FIG. 11 illustrates an example of the movable restrictions of the pan, tilt, and zoom for each lens in the image pickup apparatus 100.

As described above, this embodiment displays information indicating whether control is available to each preset item registered in the image pickup apparatus, and thereby the user can easily recognize which item is operable in operating the preset item.

### Second Embodiment

A second embodiment will illustrate an example in which the IPA control unit 120 in an image pickup apparatus (information processing apparatus) 100a displays controllable and uncontrollable items for at least one of the pan, tilt, and zoom positions among the registered preset items.

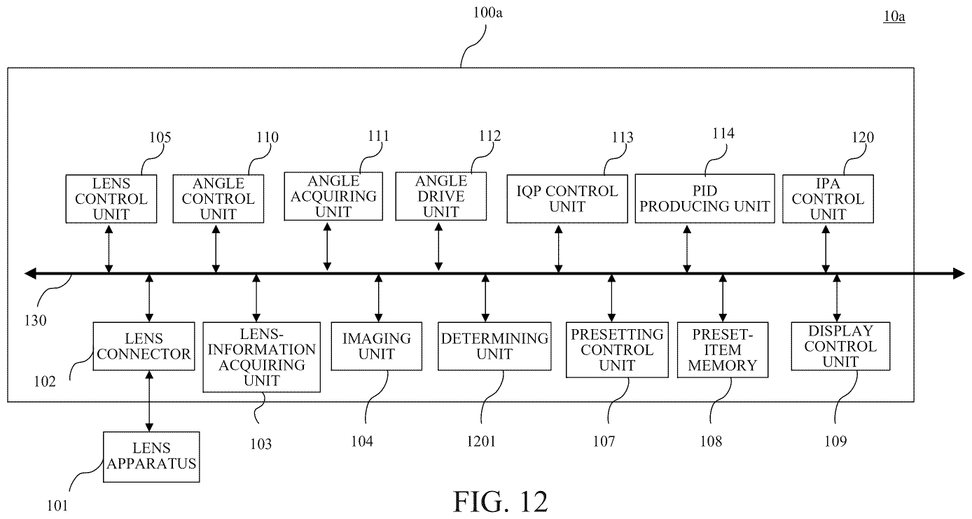

FIG. 12 is a block diagram of the imaging system 10a according to this embodiment. The imaging system 10 includes an image pickup apparatus (camera body) 100a and a lens apparatus 101 that is attachable to and detachable from the image pickup apparatus 100a. However, this embodiment is not limited to this example and can be applied to an image pickup apparatus in which the camera body and lens are integrated.

The image pickup apparatus 100a according to this embodiment differs from the image pickup apparatus 100 according to the first embodiment in that it has a determining unit (angle reproduction determining unit) 1201 instead of the determining unit (angle control determining unit) 106. This embodiment will omit a description of components similar to those according to the first embodiment.

The determining unit 1201 determines whether control is available to at least one of the zoom, pan, and tilt positions among the preset item information stored (registered) in the preset-item memory 108. This determination is made using either or both of the lens information acquired from the lens-information acquiring unit 103 and the camera settings stored in the memory of the IPA control unit 120.

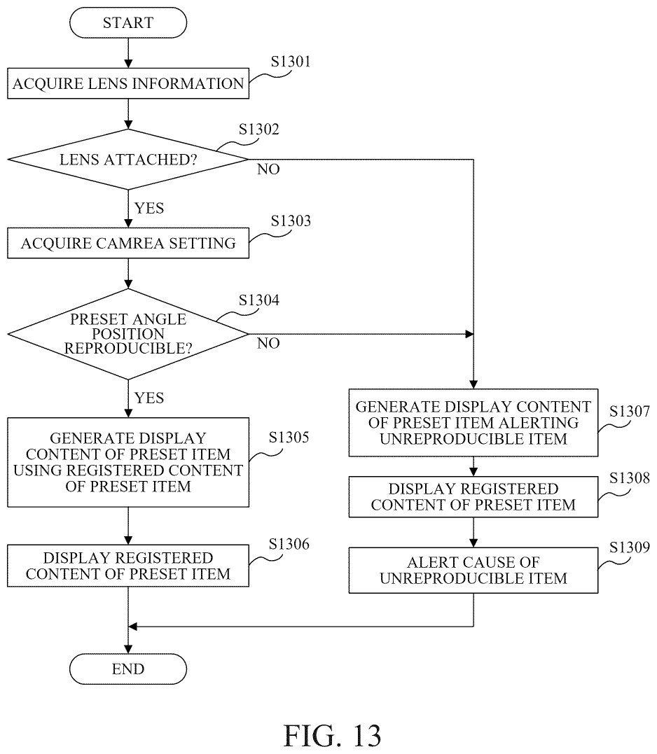

FIG. 13 is a flowchart illustrating an example of display processing of a registered content of a preset item by the image pickup apparatus 100a according to this embodiment. In FIG. 13, the lens information illustrated includes information about the lens type, focal length, and lens SW status. This processing may be performed, for example, when the lens is interchanged, at an arbitrary user-specified timing, or when the preset item information is displayed on the display device or the like.

In a case where multiple preset items are registered, this processing may be performed for each preset item. This processing may be performed on some or all of the registered preset items. In this case, there are no particular limitations on which preset item is processed, which preset item is not processed, or the processing order of the preset items to be processed. In the following description, steps S1301 to S1309 in the flowchart of FIG. 13 will be abbreviated as S1301 to S1309, respectively. Steps S1301 to S1303 and S1305 to S1306 in FIG. 13 are similar to steps S301 to S303 and S305 to S306 in FIG. 3 described according to the first embodiment, and thus a description thereof will be omitted.

In S1304, the IPA control unit 120 determines whether at least one of the zoom, pan, and tilt positions of the image pickup apparatus 100a can be controlled (changed) to at least one of the zoom, pan, and tilt positions in the preset item information stored in the preset-item memory 108. This determination is made using either or both of the lens information acquired in S1301 and the camera settings acquired in S1303 as the determination basis.

In a case where lens information is used as the determination basis, at least one of the following conditions is used: whether the lens is a zoom lens, whether the lens zoom can be controlled by a motor, whether the zoom motor control switch is automatic, and whether the preset zoom (focal length) is within the focal length range of the lens. In other words, the IPA control unit 120 determines whether the preset zoom position can be reproduced and controlled based on at least one of these conditions. In a case where camera setting is used as the determination basis, at least one of the movable limits for pan, tilt, and zoom and at least one of the movable limits for pan, tilt, and zoom for each lens is used to determine whether at least one of the preset pan, tilt, and zoom can be reproduced and controlled. In a case where the angle position is reproducible, the flow proceeds to S1305; in a case where the angle position is not reproducible, the flow proceeds to S1307.

In S1307, the IPA control unit 120 uses the PID producing unit 114 to produce a display content of a preset item in the preset item information stored in the preset-item memory 108, alerting the user that the reproduction control has been determined to be unavailable in S1304. The display that is used to alert the user that the reproduction control has been determined unavailable in S1304 is not particularly limited, and any display content different from the display content of the preset item produced in S1305 may be used. For example, the item itself may indicate that the reproduction control is not available, the color of the item may be changed, or an icon may be displayed. The flow then proceeds to S1308.

In S1308, the IPA control unit 120 displays the display content of the preset item produced by the PID producing unit 114 on the display device or the like via the display control unit 109. In a case where the processing of S1309 is omitted, the IPA control unit 120 then terminates the processing performed when preset item information is displayed based on the lens information and camera setting of the registered content of the preset item.

In S1309, the IPA control unit 120 issues an alert display on the display device or the like via the display control unit 109, regarding the cause of reproduction control determined unavailable for the content of the preset item information stored in the preset-item memory 108 for which reproduction control is determined to be unavailable in S1304. Here, the alert display is not particularly limited, and the cause may be displayed as the content of the cause, an icon of the cause, or the cause may be displayed by selecting an object. S1309 in this embodiment may be omitted. Thereafter, the IPA control unit 120 completes the processing executed when preset item information is displayed based on the lens information and camera setting of the registered content of the preset item.

Display examples of the preset item information in the image pickup apparatus 100a, which is capable of zooming, in the processing of S1306 are similar to those illustrated in FIGS. 4A, 4B, 4C, 4D, and 4E. Also, display examples of the preset item information in the image pickup apparatus 100a, which is capable of panning, tilting, and zooming, in the processing of S1306 are similar to those illustrated in FIGS. 5A, 5B, 5C, 5D, and 5E.

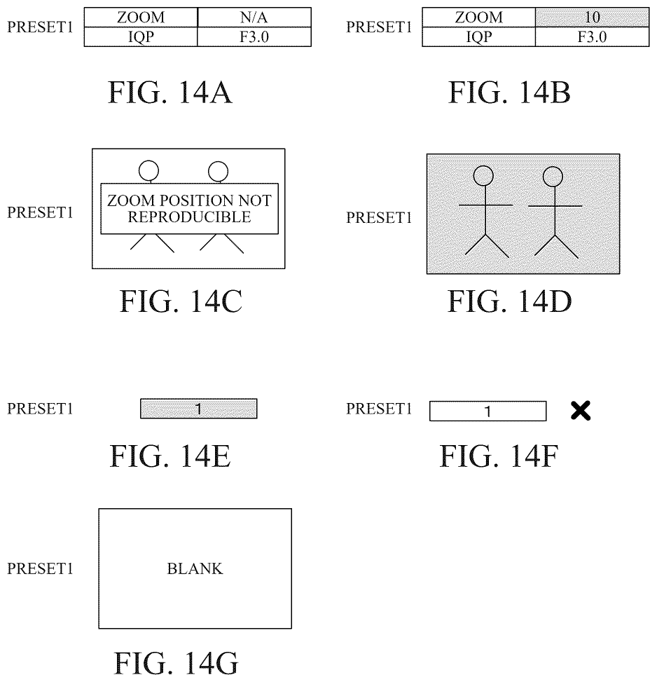

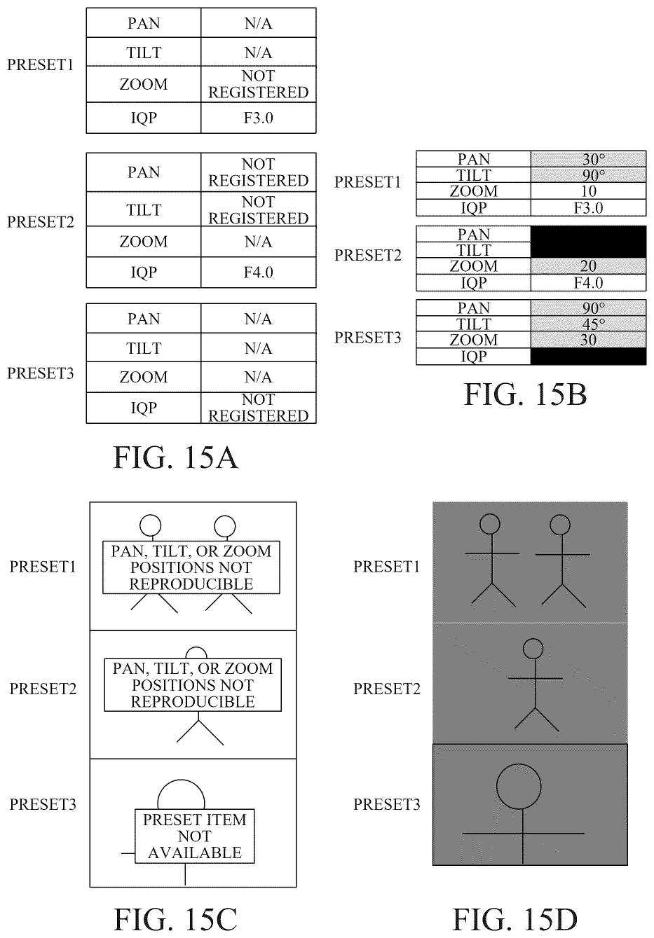

FIGS. 14A, 14B, 14C, 14D, 14E, 14F, and 14G illustrate an example of the display content of the preset item information alerting items for which preset zoom position control cannot be reproduced in the image pickup apparatus 100a, which is capable of zooming, in the processing of S1308.

FIG. 14A illustrates an alert example indicating that the reproduction control of the preset zoom position is not available, with the text “N/A.” FIG. 14B illustrates an alert example indicating that the reproduction control of the preset zoom position is not available by graying out the zoom item. FIG. 14C illustrates an alert example indicating that the reproduction control of the preset zoom position is not available, with the text “zoom position not reproducible” on a still image in the preset item information. FIG. 14D illustrates an alert example by graying out a still image in the preset item information to indicate that the reproduction control of the preset zoom position is not available.

FIG. 14E illustrates an alert example by graying out an icon to indicate that the reproduction control of the preset zoom position is not available. FIG. 14F illustrates an alert example by displaying an icon indicating that the reproduction control of the preset zoom position is not available. FIG. 14G illustrates an alert example by hiding a still image in the preset item information to indicate that the reproduction control of the preset zoom position is not available.

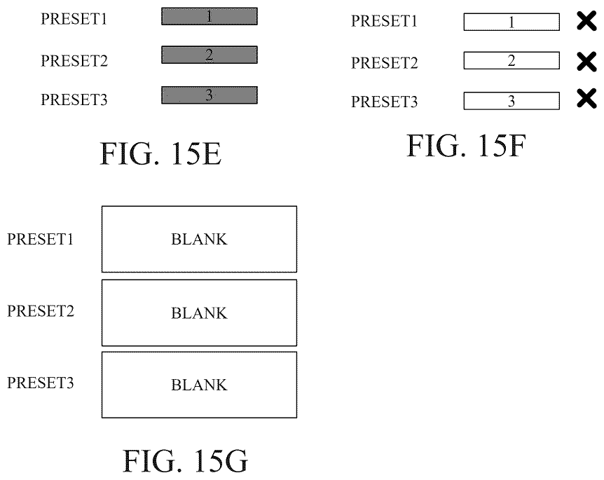

FIGS. 15A, 15B, 15C, 15D, 15E, 15F, and 15G illustrate display examples of preset item information alerting that the reproduction control of at least one of the preset zoom, pan, and tilt positions is not available in the image pickup apparatus 100a, which is capable of panning, tilting, and zooming, in the processing of S1308. The examples in FIGS. 15A, 15B, 15C, 15D, 15E, 15F, and 15G illustrate display examples of the preset item information in a case where reproduction control is not available for all of pan, tilt, and zoom, but the display of no reproduction control may be made for each of pan, tilt, and zoom.

FIG. 15A illustrates an alert example indicating that the reproduction control of the preset zoom, pan, and tilt positions is not available, with the text “N/A.” FIG. 15B illustrates an alert example indicating that the reproduction control of the preset zoom, pan, and tilt positions is not available by graying out the zoom, pan, and tilt items. FIG. 15C illustrates an alert example indicating that the reproduction control of the preset zoom, pan, and tilt positions is not available by displaying a still image in the preset item information, with the text “pan, tilt, or zoom not reproducible.” FIG. 15D illustrates an alert example indicating that the reproduction control of the preset zoom, pan, and tilt positions is not available by graying out a still image in the preset item information.

FIG. 15E illustrates an alert example by graying out the icon to indicate that the reproduction control of the preset zoom, pan, and tilt positions is not available. FIG. 15F illustrates an alert example by displaying an icon indicating that the reproduction control of the preset zoom, pan, and tilt positions is not available. FIG. 15G illustrates an alert example by hiding the still image in the preset item information to indicate that the reproduction control of the preset zoom, pan, and tilt positions is not available.

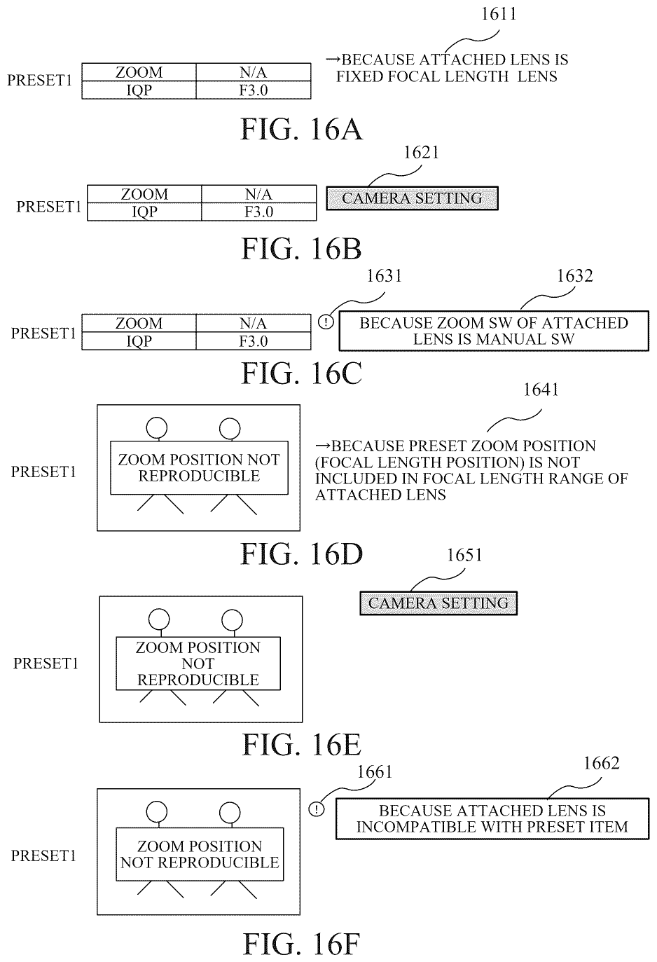

FIGS. 16A, 16B, 16C, 16D, 16E, and 16F illustrate alert examples of causes of the reproduction control not available to the preset zoom position in the image pickup apparatus 100a, which is capable of zooming, in the processing of S1309.

FIG. 16A illustrates an alert example of the cause of the reproduction control not available to the preset zoom position using a text. Reference numeral 1611 denotes a text example indicating that the zoom position cannot be reproduced, and it is not limited to this example. FIG. 16B illustrates an alert example of the cause of the reproduction control not available to the preset zoom position using an icon. Reference numeral 1621 denotes an alert example of the cause of the reproduction control not available to the preset zoom position using a camera setting icon, but it is not limited to this example. FIG. 16C illustrates an alert example of the cause of the reproduction control not available for the preset zoom position, by selecting an object. Reference numeral 1631 denotes an object example indicating the cause of the reproduction control not available to the preset zoom position, and reference numeral 1632 denotes a display example of the cause of the reproduction control not available by operating the object in 1631, but it is not limited to this example.

FIG. 16D illustrates an alert example of the cause of the reproduction control not available to the preset zoom position, with a text. Reference numeral 1641 denotes a text example indicating that the reproduction control of the zoom position is not available, but it is not limited to this example. FIG. 16E illustrates an alert example of the cause of the reproduction control not available to the preset zoom position using an icon. Reference numeral 1651 denotes an alert example of the cause of the reproduction control not available to the preset zoom position, using a camera setting icon, but it is not limited to this example. FIG. 16F illustrates an alert example of the cause of the reproduction control not available to the preset zoom position, by selecting an object. Reference numeral 1661 denotes an object example indicating the cause of the reproduction control not available to the preset zoom position, and reference numeral 1662 denotes a display example of the cause of the reproduction control not available to the preset zoom position by operating the object in 1661, but it is not limited to this example.

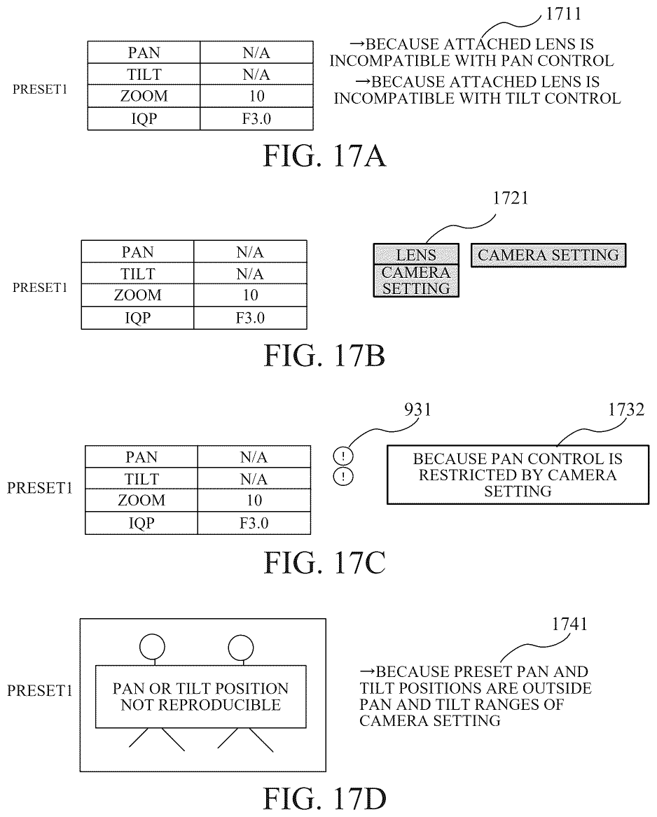

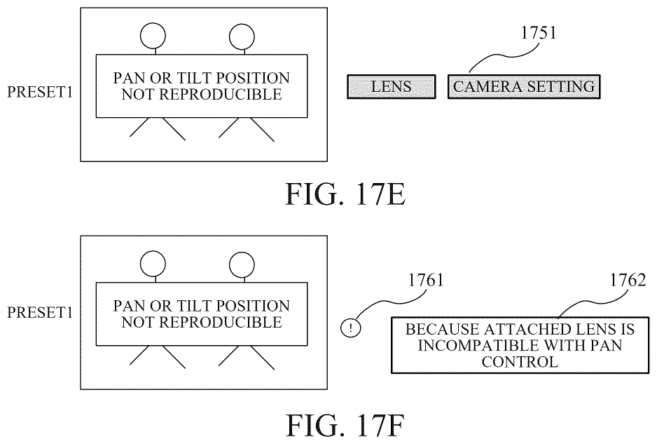

FIGS. 17A, 17B, 17C, 17D, 17E, and 17F illustrate alert examples of the cause of the reproduction control not available to the preset pan and tilt positions in the image pickup apparatus 100a, which is capable of panning, tilting, and zooming, in the processing of step S1309.

FIG. 17A illustrates an alert example of the cause of the reproduction control not available to the preset pan and tilt positions using a text. Reference numeral 1711 denotes a text example indicating that the reproduction control of the preset pan position is not available, but it is not limited to this example. FIG. 17B illustrates an alert example of the cause of the reproduction control not available to the preset pan and tilt positions using an icon. Reference numeral 1721 denotes a text example indicating that the reproduction control of the preset pan position is not available using a lens icon, but it is not limited to this example. FIG. 17C illustrates an alert example of the cause of the reproduction control not available to the preset pan and tilt positions by selecting an object. Reference numeral 1731 denotes an object example indicating the cause of the reproduction control not available to the preset pan position, and reference numeral 1732 denotes a text example indicting the cause of the reproduction control not available to the preset pan and tilt positions by operating the object 1731, but it is not limited to this example.

FIG. 17D illustrates an alert example of the cause of the reproduction control not available to the preset pan and tilt positions using text. Reference numeral 1741 is a text example indicating the cause of the reproduction control not available to the preset pan and tilt positions, but it is not limited to this example. FIG. 17E illustrates an alert example of the cause of the reproduction control not available to the preset pan and tilt positions using an icon. Reference numeral 1751 denotes an alert example of the cause of the reproduction control not available to the preset pan and tilt positions using a lens icon, but it is not limited to this example. FIG. 17F illustrates an alert example of the cause of the reproduction control not available to the preset pan and tilt positions by selecting an object. Reference numeral 1761 denotes an object example indicating the cause of the reproduction control not available for the preset pan and tilt positions, and reference numeral 1762 denotes a display example of a cause of reproduction control not available for the preset pan and tilt positions by operating the object 1761, but it is not limited to this example.

Thus, this embodiment displays information indicating whether reproduction control is available to at least one of the preset pan, tilt, and zoom positions registered in the image pickup apparatus. Thereby, the user can easily recognize an item in which reproduction control of the angle position is available in operating the preset item.

### Third Embodiment

The first and second embodiments have discussed methods for displaying the preset item information using the image pickup apparatus. On the other hand, the third embodiment will discuss a method for displaying the preset item information using an information processing apparatus.

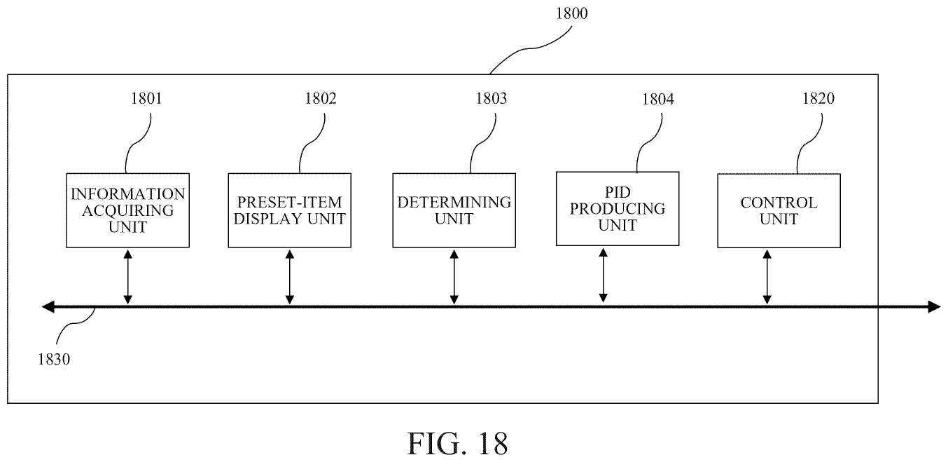

FIG. 18 is a block diagram of an information processing apparatus 1800 according to this embodiment. The information processing apparatus 1800 includes an information acquiring unit (acquiring unit) 1801, a preset-item display unit 1802, a determining unit 1803, a preset-item display (PID) producing unit 1804, a control unit 1820, and a data bus 1830.

The control unit 1820 includes a CPU, memory, and nonvolatile memory. The memory is, for example, RAM (volatile memory using semiconductor elements, etc.). The nonvolatile memory stores a variety of programs for operating the CPU. The nonvolatile memory includes, for example, a hard disk drive (HDD) or ROM. The CPU performs various processing using the memory as work memory in accordance with the programs stored in the nonvolatile memory, for example. Each component in the information processing apparatus 1800 is controlled by a program running on the control unit 1820, and communicates data with each other via the data bus 1830.

The information acquiring unit 1801 communicates with the image pickup apparatus. During this communication, it receives data such as preset item information, lens information, and camera settings stored (registered) in the memory unit of the image pickup apparatus.

The preset-item display unit 1802 acquires a display content of a preset item produced by the PID producing unit 1804 in accordance with a control command and control information received from the control unit 1820. The preset-item display unit 1802 then edits display data to be displayed on the display device (display apparatus, display unit) (not illustrated) and controls the display.

The determining unit 1803 uses either or both of the lens information and camera setting acquired from the information acquiring unit 1801 to determine whether control is available to at least one of the zoom, pan, and tilt positions of the preset item information acquired by the information acquiring unit 1801. In other words, the determining unit 1803 determines whether the operation (control or reproduction) corresponding to the preset item information can be executed.

The PID producing unit 1804 acquires the preset item information received by the information acquiring unit 1801 and produces the display content of the preset item. The PID producing unit 1804 can edit the display content of the preset item based on the determination result of the determining unit 1803.

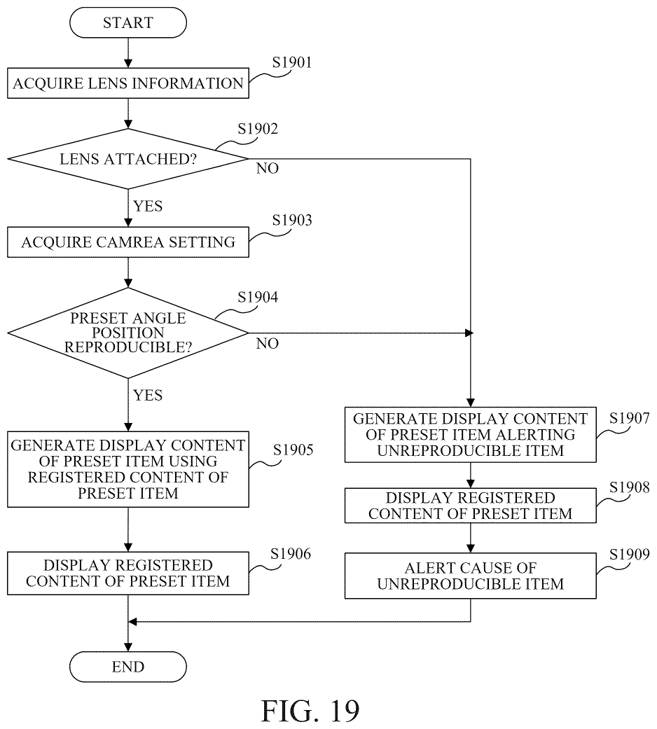

FIG. 19 is a flowchart illustrating an example of the display processing of registered content of the preset item by the information processing apparatus 1800 according to this embodiment. In FIG. 19, lens information is illustrated as information about the lens type, focal length, and lens SW status. This processing may be performed, for example, when the information is acquired from the image pickup apparatus, at an arbitrary timing selected by the user, or when the preset item information is displayed on the display device, etc.

In a case where multiple preset items are registered, this processing may be performed for each preset item. It may also be performed for some or all of the registered preset items. In this case, there are no particular limitations on which preset item is processed, which preset item is not processed, or the processing order of the preset items to be processed. In the following description, steps S1901 to S1909 in the flowchart in FIG. 19 will be abbreviated as S1901 to S1909, respectively.

First, in S1901, the control unit 1820 acquires at least one piece of information (lens information) from the information acquiring unit 1801 via the data bus 1830: the lens focal length range, lens type, lens SW status, and whether or not a lens is attached. The flow then proceeds to S1902.

In S1902, the control unit 1820 uses the lens information acquired in S1901 as the determination basis whether or not a lens is attached to the image pickup apparatus. In a case where the lens is attached, the flow proceeds to S1903; in a case where the lens is not attached, the flow proceeds to S1906.

In S1903, the control unit 1820 acquires at least one piece of information (camera setting) from the information acquiring unit 1801: the movable limit setting for at least one of zoom, pan, and tilt, and the movable limit setting for at least one of zoom, pan, and tilt for each lens. The flow then proceeds to S1904.

In S1904, the control unit 1820 determines whether the preset angle position can be reproduced, using either or both of the lens information acquired in S1901 and the camera setting acquired in S1903 as the determination basis. That is, the control unit 1820 determines whether at least one of the zoom, pan, and tilt positions of the image pickup apparatus can be controlled (changed) to at least one of the zoom, pan, and tilt positions in the preset item information acquired by the information acquiring unit 1801.

In a case where lens information is used as the determination basis, the determination basis includes at least one of the following: whether the lens is a zoom lens, whether the zoom of the lens can be controlled by a motor, whether the zoom motor control SW is automatic, and whether the preset zoom (focal length) is within the focal length range of the lens. In a case where camera setting is used as the determination basis, the control unit 1820 determines whether at least one of the preset pan, tilt, and zoom positions can be reproduced, using at least one of the movable limits for pan, tilt, and zoom and at least one of the movable limits for pan, tilt, and zoom for each lens. In a case where the preset angle position is reproducible, the flow proceeds to S1905; in a case where the preset angle position is not reproducible, the flow proceeds to S1907.

In S1905, the control unit 1820 causes the PID producing unit 1804 to produce a display content of a preset item using the preset item information acquired by the information acquiring unit 1801. Here, the display content to be produced is not particularly limited, and may be a list display, overview display, icon display, or thumbnail display in a case where the preset item information includes a still image. The flow then proceeds to S1906.

In S1906, the control unit 1820 displays the display content of the preset item produced by the PID producing unit 1804 on the display device or the like via the preset-item display unit 1802. The control unit 1820 then terminates the processing executed when the preset item information is displayed based on the lens information and camera setting of the registered content of the preset item.

In S1907, the control unit 1820 causes the PID producing unit 1804 to produce the display content of the preset item that alerts the preset item information acquired by the information acquiring unit 1801 of the content for which reproduction control has been determined unavailable in S1904. Here, the display that is used to alert the content for which reproduction control has been determined unavailable in S1904 is not particularly limited, and can be anything different from the display content of the preset item generated in S1905. For example, the item may be displayed to indicate that it cannot be reproduced, the color of the item may be changed, or an icon may be displayed. The flow then proceeds to S1908.

In S1908, the control unit 1820 displays the display content of the preset item produced by the PID producing unit 1804 on the display device or the like via the preset-item display unit 1802. In a case where the processing of S1909 is omitted, the control unit 1820 then terminates the processing executed when the preset item information is displayed based on the lens information and camera setting of the registered content of the preset item.

In S1909, the control unit 1820 issues an alert display of the cause of reproduction control not available for the content for which reproduction control has been determined unavailable in S1904, based on the preset item information acquired by the information acquiring unit 1801 to be displayed on the display device or the like via the preset-item display unit 1802. Here, the alert display is not particularly limited, and may display the cause content, an icon for the cause, or the cause may be displayed by selecting an object. S1909 in this embodiment may be omitted. Thereafter, the control unit 1820 terminates the processing executed when the preset item information is displayed based on the lens information and camera settings of the registered content of the preset items.

Display examples of the preset item information in the image pickup apparatus, which is capable of zooming, in the processing of S1906 are similar to those illustrated in FIGS. 4A, 4B, 4C, 4D, and 4E. Also, display examples of the preset item information in the image pickup apparatus, which is capable of panning, tilting, and zooming, in the processing of S1906 are similar to those illustrated in FIGS. 5A, 5B, 5C, 5D, and 5E.

Display examples of the preset item information alerting an item for which reproduction control is not available to the preset zoom position in the image pickup apparatus, which is capable of zooming, in the processing of S1908 are similar to those illustrated in FIGS. 14A, 14B, 14C, 14D, 14E, 14F, and 14G. Also, display examples of the preset item information alerting an item for which reproduction control is not available to the preset zoom, pan, and tilt positions in the image pickup apparatus, which is capable to panning, tilting, and zooming, in the processing of S1908 are similar to those illustrated in FIGS. 15A, 15B, 15C, 15D, 15E, 15F, and 15G.

Display examples of the preset item information alerting the cause of the item for which the reproduction control is not available to the preset zoom position in the image pickup apparatus, which is capable of zooming, in the processing of S1909 are similar to those illustrated in FIGS. 16A, 16B, 16C, 16D, 16E, and 16F. Also, display examples of the preset item information alerting the cause of the item for which the reproduction control is not available to the preset pan and tilt positions in the image pickup apparatus, which is capable of panning, tilting, and zooming, in the processing of S1909 are similar to those illustrated in FIGS. 17A, 17B, 17C, 17D, 17E, and 17F.

Thus, in this embodiment, the information processing apparatus displays information indicating whether or not the reproduction control is available to at least one of the pan, tilt, and zoom positions of the presets registered in the image pickup apparatus. Thereby, the user can easily recognize a reproduction control item among the angle positions in operating the preset item.

Each embodiment displays on the display unit information indicating whether reproduction control is available to at least one of the pan, tilt, and zoom positions among the preset items registered in the image pickup apparatus. Thereby, the user can easily recognize the reproduction control item among the angle position in operating the preset item.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

This application claims the benefit of Japanese Patent Application No. 2024-209681, which was filed on Dec. 2, 2024, and which is hereby incorporated by reference herein in its entirety.

What is claimed is:

1. An information processing apparatus comprising:
one or more memories storing instructions; and
one or more processors that, upon execution of the instructions, operate to:
acquire preset item information,
cause a display unit to display the preset item information, and
cause the display unit to change a display content of the preset item information according to whether at least one of a lens apparatus and an image pickup apparatus can execute an operation corresponding to the preset item information.

2. The information processing apparatus according to claim 1, wherein the operation is control corresponding to the preset item information.

3. The information processing apparatus according to claim 1, wherein the operation is reproduction of a setting corresponding to the preset item information.

4. The information processing apparatus according to claim 1, wherein the preset item information includes information on at least one of a zoom position, a pan position, a tilt position, and an image quality parameter.

5. The information processing apparatus according to claim 1, wherein the one or more processors operate to determine whether the operation can be executed using at least one of lens information on the lens apparatus and setting information on the image pickup apparatus.

6. The information processing apparatus according to claim 5, wherein the lens information includes at least one of information on whether the lens apparatus is attached, information on a type of the lens apparatus, information on whether a power zoom function of the lens apparatus is enabled, and information on a focal length.

7. The information processing apparatus according to claim 5, wherein the setting information includes information on an image quality parameter and information on a movable limit setting for at least one of a zoom position, a pan position, and a tilt position.

8. The information processing apparatus according to claim 1, wherein the one or more processors operate to determine that the operation cannot be executed in a case where the lens apparatus is not attached to the image pickup apparatus.

9. The information processing apparatus according to claim 1, wherein the preset item information includes a captured image, and
wherein in a case where the one or more processors determines that the operation cannot be executed, the one or more processors operate to issue an alert that the operation cannot be executed, in the captured image displayed on the display unit.

10. The information processing apparatus according to claim 1, wherein in a case where the one or more processors determines that the operation cannot be executed, the one or more processors operate to issue an alert that the operation cannot be executed, in a list of preset item information displayed on the display unit.

11. The information processing apparatus according to claim 1, wherein in a case where the one or more processors determines that the operation cannot be executed, the one or more processors operate to alert a cause of the operation being inexecutable to the display unit.

12. The information processing apparatus according to claim 1, wherein in a case where the one or more processors determines that the operation cannot be executed, the one or more processors operate to display setting information about the image pickup apparatus on the display unit.

13. An image pickup apparatus comprising:
an information processing apparatus;
an image sensor,
wherein the information processing apparatus includes:
one or more memories storing instructions; and
one or more processors that, upon execution of the instructions, operate to:
acquire preset item information,
cause a display unit to display the preset item information, and
cause the display unit to change a display content of the preset item information according to whether at least one of a lens apparatus and an image pickup apparatus can execute an operation corresponding to the preset item information.

14. The image pickup apparatus according to claim 13, wherein the lens apparatus is attachable to and detachable from the image pickup apparatus.

15. The image pickup apparatus according to claim 13, further comprising the display unit configured to display the preset item information.

16. The image pickup apparatus according to claim 13, wherein the one or more memories further store the preset item information.

17. An information processing method comprising:
acquiring preset item information;
causing a display unit to display the preset item information; and
causing the display unit to change a display content of the preset item information according to whether at least one of a lens apparatus and an image pickup apparatus can execute an operation corresponding to the preset item information.

18. A non-transitory computer-readable storage medium storing a program that causes a computer to execute the information processing method according to claim 17.
